(19) United States
(12) Patent Application Publication
(10) Pub. No.: US 2008/0032581 A1
(43) Pub. Date: Feb. 7, 2008

(54) Disposable travel linen

(76) Inventors: Dorothy Mae Avery, Birmingham, AL (US); Mitchell Kevin Avery, Birmingham, AL (US)

Correspondence Address: Dorothy & Michell Avery, 1210 Old Oak Road, Birmingham, AL, 35235, US

(21) Appl. No.: 11/400,713

(22) Filed: Aug. 1, 2006

(51) Int. Cl. D03D 15/00; B32B 27/12; D03D 25/00

(52) U.S. Cl. 442/394; 442/181; 442/261; 442/286

(57) ABSTRACT

A fitted and flat sheet set (with matching pillow cases) that will come in king, queen, full and twin bed sizes. The sheet sets can be constructed from a variety of fabrics, such as cotton, polyester, satin, etc. There is a plastic or bio-fiber lining sewn between layers of the above mentioned fabric for protection. Each corner of the fitted sheet is rendered stretchable by an elastic strip, whereby the fitted sheet conforms snugly to the mattress but the flat sheet is tucked under the mattress.

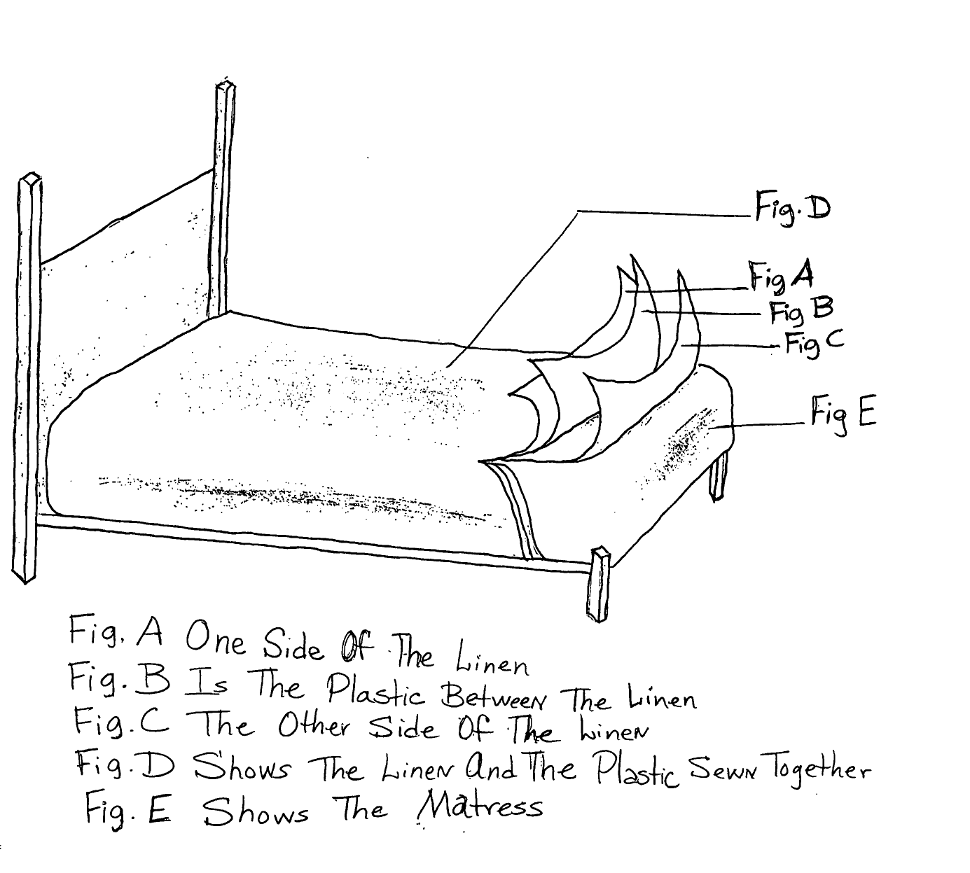

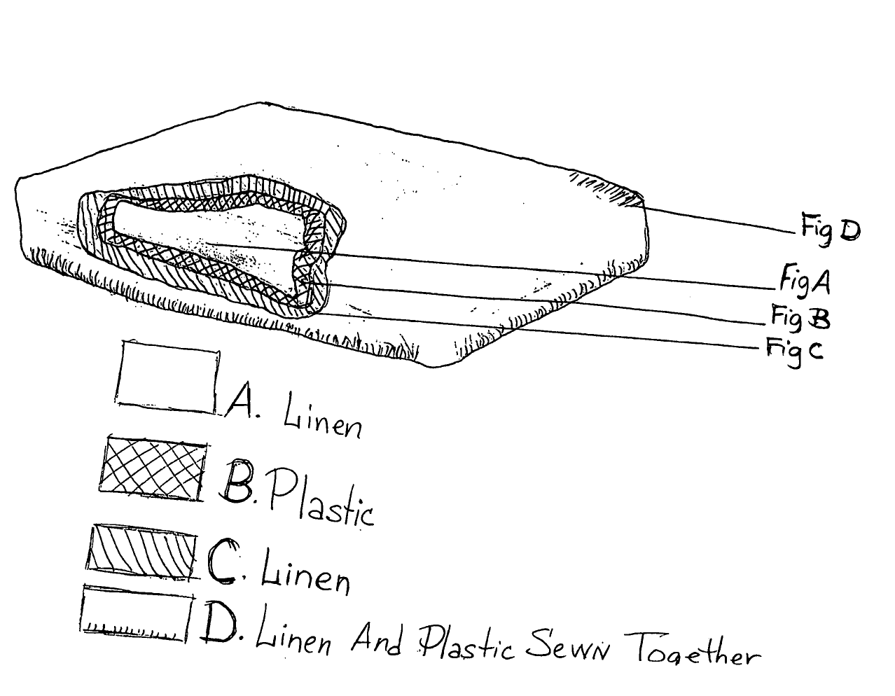

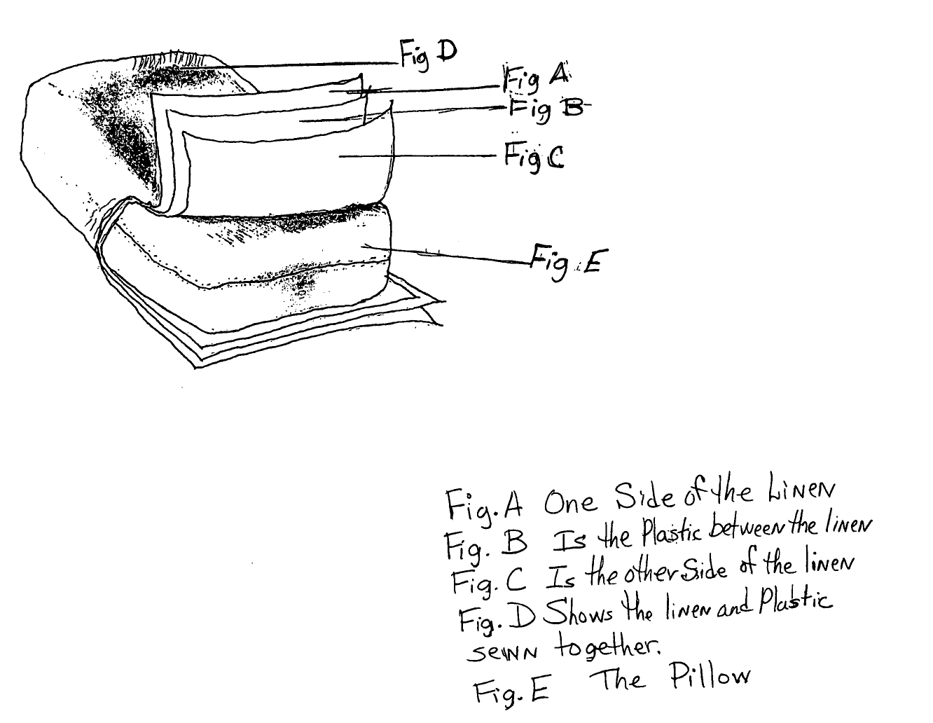

The concept of DISPOSABLE TRAVEL LINEN, is a line of disposable sheets and pillowcases for commercial and home use that would provide a person with a safe and germ free surface upon which to sleep. This improved bedding, if manufactured, would give a hotel guest peace of mind to sleep comfortably knowing that he was protected from bed bugs and dead skin cells.

The “DISPOSABLE TRAVEL LINEN” would consist of a line of lightweight, satin, cotton or polyester bedding that would feature a thin plastic lining. This plastic lining would be used to prevent the dead skin cells from others from penetrating through the pillow or mattress.

For use, the user would simply make the bed as usual. With the “DISPOSABLE TRAVEL LINEN” a person could sleep in comfort and knowing that he/she would avoid possible contamination from other individuals. After use, this bedding could be easily removed and simply thrown away. The “DISPOSABLE TRAVEL LINEN” could be produced in twin, full, queen, and king sizes. As a variation, this modernized bedding could be ideal for use by children who still wet the bed.

I believe it would fulfill the need for an improved line of bedding that would increase the sanitary conditions in any hotel, motel, or residence. The appealing features of the “DISPOSABLE TRAVEL LINEN” would be its sanitary qualities, convenience, timesaving, practicality, effectiveness, attractiveness, light weight, disposable design, and ease of use. This disposable bedding would provide a protective barrier between the user and dead skin cells and bed bugs that can permeate the surface of standard bed linens.

With this disposable line of bedding, hotel and motel guests would have peace of mind knowing that sheets and pillowcases would always be fresh and clean. This modernized bedding would benefit individuals who frequently travel and stay in hotels and motel.

Fig. A is a view of one side of the linen

Fig. B is a view of the plastic between the linen

Fig. C is a view of the other side of the linen

Fig. D shows the linen and the plastic sewn together

Fig. E shows the mattress

1. I claim that “DISPOSABLE TRAVEL LINEN” will protect a person from contacting germs, and it will also prevent bed bugs and dead skin cells from permeating through the linen from the mattress. It will also give a person peace of mind, which would contribute to a comfortable and restful night sleep.
